(19) United States
(12) Patent Application Publication
(10) Pub. No.: US 2025/0154034 A1
(43) Pub. Date: May 15, 2025

(54) Materials and Methods for Recovering Minerals from Industrial Wastewater

(71) Applicant: Locus Solutions IPCo, LLC, Solon, OH (US)

(72) Inventors: Gabriela KNESEL, Solon, OH (US); Ronney SILVA, Solon, OH (US); Cathrine MONYAKE, Solon, OH (US); Juan CERVANTES, Solon, OH (US)

(21) Appl. No.: 18/839,540

(22) PCT Filed: Jul. 15, 2023
(86) PCT No.: PCT/US2023/070294

§ 371 Date: Aug. 19, 2024

Related U.S. Application Data
(60) Provisional application No. 63/390,732, filed on Jul. 20, 2022.
(60) Provisional application No. 63/503,228, filed on May 19, 2023.

(51) Int. Cl. C02F 1/52; C02F 1/40; C02F 3/34; C02F 101/10; C02F 103/10; C02F 103/36

(52) U.S. Cl. CPC C02F 1/5263; C02F 1/40; C02F 3/347; C02F 2101/10; C02F 2103/10; C02F 2103/365; C02F 2305/04

(57) ABSTRACT

The subject invention provides safe, environmentally-friendly compositions and efficient methods for recovering materials from industrial wastewater. More specifically, the subject invention provides compositions derived from microorganisms for recovery of metals, elements, compounds, and minerals, which can be used for creating useful products.

### CROSS-REFERENCE TO RELATED APPLICATIONS

This application claims priority to U.S. Provisional Patent Application No. 63/390,732, filed Jul. 20, 2022, and No. 63/503,228, filed May 19, 2023, both of which are incorporated herein by reference in their entirety.

### BACKGROUND OF THE INVENTION

Oil and gas production wells, mining sites, and quarrying sites generate large volumes of water mixed with hydrocarbons (dispersed and dissolved), salts (e.g., sodium, calcium, magnesium, lithium, sulfates, and carbonates), minerals, elements, compounds, metals, and solids. This industrial wastewater is usually viewed as a waste stream that must be disposed of appropriately, as the presence of toxic hydrocarbons, metals, and ions makes it unsuitable for surface discharge or disposal into groundwater. However, the supply of global freshwater sources is diminishing, and the demand for water in industrial, domestic, and agricultural use in water-stressed regions makes industrial wastewater an attractive resource.

Currently, salts are the primary product derived from oil and gas production wastewater. The majority of salts have limited commercial appeal as they are low value products. If higher value products can be isolated from industrial wastewater, further commercial interest may arise.

Industrial wastewater can also contain valuable elements, compounds, metals, and minerals, including lithium and rare earth elements. The presence of metals, minerals, elements, compounds, and other material that have the ability to be used in the creation of valuable products, including, for example, lithium-based batteries and electronics.

Various approaches exist for disposing of industrial wastewater, including, for example, injecting the wastewater into deep geological formations. However, ever increasing concern of contaminated groundwater in addition to the potential use of the compounds found in the wastewater for commercial purposes necessitate safe and efficient recovery of metals and minerals from industrial wastewater. Therefore, novel, improved methods are needed for recovering metals and minerals from industrial wastewater.

### BRIEF SUMMARY OF THE INVENTION

The subject invention relates generally to the recovery of metals, minerals, elements, compounds, and other material from industrial wastewater, including, for example, produced water. More specifically, the subject invention provides environmentally-friendly compositions and methods for recovering metals, minerals, elements, compounds, and other material, such as, for example, lithium and copper, from industrial water. In certain embodiments, the recovered metals, minerals, elements, compounds, and other material can be safely discarded using methods known in the art; while, in other embodiments, the recovered metals, minerals, elements, compounds, and other material can be recycled and/or processed for other uses.

Advantageously, the compositions and methods of the subject invention recover metals, minerals, elements, compounds, and other material from industrial wastewater and can decrease the chemical usage required for processing wastewater. Further, the recovered metals, minerals, elements, compounds, and other material can be formed into useful products, such as electronics, heat shielding, batteries, fertilizer, wiring, and jewelry. Additionally, the subject invention can be useful for reducing the ground and water pollution created during the processing of mined ores, petroleum, and natural gas by reducing the use and presence of toxic chemicals.

In certain embodiments, the subject invention provides compositions comprising components that are derived from microorganisms. In certain embodiments, the composition comprises a microbial biosurfactant. In certain embodiments, the composition comprises biosurfactants, and, optionally, other compounds, such as, for example, chemical surfactants, activated carbon (i.e., a carbon-based material processed in a way to increase its surface area), zeolites (e.g., clinoptilolite), clays (e.g., natural or organoclays), ion exchanging agents, polymers, adsorbents (e.g., starch, alginate, chitin, chitosan, aluminum salts), salts (e.g., sodium carbonate, aluminum chloride), acids (e.g., phosphoric acid), or any combination thereof.

In certain embodiments, the biosurfactant of the composition is utilized in crude form. The crude form can comprise, in addition to the biosurfactant, fermentation broth in which a biosurfactant-producing microorganism was cultivated, residual microbial cell material or live or inactive microbial cells, residual nutrients, and/or other microbial growth by-products.

In some embodiments, the biosurfactant is utilized after being extracted from a fermentation broth and, optionally, purified.

The biosurfactant according to the subject invention can be a glycolipid (e.g., sophorolipids, rhamnolipids, cellobiose lipids, mannosylerythritol lipids and trehalose lipids), lipopeptide (e.g., surfactin, iturin, fengycin, arthrofactin, and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP, esterified SLP derivatives, amino acid-SLP conjugates, and other SLP derivatives or isomers that exist in nature and/or are produced synthetically. In preferred embodiments, the SLP is a linear SLP or a derivatized linear SLP.

In certain embodiments, the surfactant of the composition is a detergent, wetting agent, emulsifier, foaming agent, and/or dispersant.

In certain embodiments, the subject invention provides a method for recovering metals, minerals, elements, compounds, and other material from industrial wastewater, wherein the method comprises the following steps: (i) contacting a composition according to the subject invention with industrial wastewater for a period of time to yield a mixture comprising treated wastewater; and (ii) separating the metals, minerals, elements, compounds, and other material from the remaining wastewater.

The method can be carried out using, for example, a column, a filter, a membrane, a solvent, electrolysis, or using any other laboratory or industrial sized reactor.

In some embodiments, step (i) comprises applying a recovery composition comprising a biosurfactant and, optionally, other components, such as, for example, chemical surfactants, activated carbon, zeolites, clays, ion exchanging agents, polymers, adsorbents, salts, and/or acids, to the industrial wastewater. In certain embodiments, the mixture can be pumped or otherwise moved through a membrane, column, resin, adsorbent, or filter. Step (i) can be repeated as many times as necessary to achieve a desired recovery of metals, minerals, elements, compounds, and other material from industrial wastewater.

In certain embodiments, the source of the industrial wastewater is produced water. Produced water is naturally occurring water that is removed from the ground during the extraction of oil and gas, as geological formations that contain oil and gas also contain water.

In certain embodiments, the source of the industrial wastewater is groundwater or precipitation at industrial sites, including, for example, mines, quarries, and oil and gas wells.

In certain embodiments, the source of the industrial wastewater is the water that is pumped or otherwise applied into the ground or geologic formation, during, for example, hydraulic fracturing.

In some embodiments, the method enhances or increases the rate of recovery and/or the amount of recovered metals, minerals, elements, compounds, and other material that can be less than about 1 mm, about 500 μm, about 100 μm, about 10 μm, about 1 μm, about 100 nm, about 10 nm, or about 1 nm in diameter.

In certain embodiments, the composition according to the subject invention is effective due to enhancing and/or increasing the rate of agglomeration of particles of metals, minerals, elements, compounds, and other material to each other or to a surface (e.g., filter, membrane, adsorbent, or column) from a liquid containing the particles. For example, in some embodiments, a sophorolipid will form a micelle containing or linking the particles, wherein the micelle is less than 500 μm, less than 100 μm, less than 10 μm, less than 1 μm, less than 100 nm, less than 50 nm, less than 25 nm, less than nm or less than 10 nm in size.

In certain embodiments, the methods of the subject invention result in at least a 25% increase in the recovery of particles, preferably at least a 50% increase, after one treatment. In certain embodiments, the industrial wastewater can be treated multiple times to further increase the amount of recovered particles.

In some embodiments, the metals, minerals, elements, compounds, or other material is obtained in a raw form. This raw form can comprise additional material, or gangue material. In certain embodiments, the method can further comprise, after obtaining the metals, minerals, elements, compounds, or other material, subjecting the metals, minerals, elements, compounds, or other material to one or more beneficiation processes. The one or more beneficiation processes can include, for example, comminution, scrubbing, washing, screening, flotation, and/or hydrocycloning.

Advantageously, in certain embodiments, the composition according to the subject invention can be effective at recovering toxic compounds from industrial wastewater. Furthermore, the methods of the subject invention do not require complicated equipment or high energy consumption, and production of the composition can be performed on site, for example, at a mine or at an oil well.

### DETAILED DESCRIPTION

The subject invention relates generally to the recovery of metals, minerals, elements, compounds, or other material from industrial wastewater. More specifically, the subject invention provides environmentally-friendly compositions and methods for extracting metals, minerals, elements, compounds, or other material, such as, for example, copper and lithium, from industrial wastewater. In certain embodiments, the metals, minerals, elements, compounds, or other material can be safely discarded using methods known in the art, while in other embodiments the metals, minerals, elements, compounds, or other material can be recycled and/or processed for other uses to reduce waste and pollution.

Advantageously, the compositions and methods of the subject invention increase the yield of metals, minerals, elements, compounds, or other material from industrial wastewater than can be used to create useful products, such as jewelry, batteries, and in electronics. Accordingly, the subject invention is useful for improving the efficiency of recovering metals, minerals, elements, compounds, or other material.

### Selected Definitions

As used herein, “applying” a composition or product refers to contacting it with a target or site such that the composition or product can have an effect on that target or site. The effect can be due to, for example, microbial growth and/or the action of a biosurfactant or other microbial growth by-product.

As used herein, a “biofilm” is a complex aggregate of microorganisms, such as bacteria, yeast, or fungi, wherein the cells adhere to each other and/or to a surface using an extracellular matrix. The cells in biofilms are physiologically distinct from planktonic cells of the same organism, which are single cells that can float or swim in liquid medium.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. An isolated microbial strain means that the strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism or a substance necessary for taking part in a particular metabolic process. A metabolite can be an organic compound that is a starting material, an intermediate in, or an end product of metabolism. Examples of metabolites include, but are not limited to, enzymes, acids, solvents, alcohols, proteins, vitamins, minerals, microelements, amino acids, biopolymers and biosurfactants.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein a “reduction” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

As used herein, “surfactant” means a compound that lowers the surface tension (or interfacial tension) between two liquids or between a liquid and a solid. Surfactants act as, e.g., detergents, wetting agents, emulsifiers, foaming agents, and/or dispersants. A “biosurfactant” is a surface-active substance produced by a living cell and/or using naturally-derived substrates.

Biosurfactants are a structurally diverse group of surface-active substances consisting of two parts: a polar (hydrophilic) moiety and non-polar (hydrophobic) group. Due to their amphiphilic structure, biosurfactants can, for example, increase the surface area of hydrophobic water-insoluble substances, increase the water bioavailability of such substances, and change the properties of bacterial cell surfaces. Biosurfactants can also reduce the interfacial tension between water and oil and, therefore, lower the hydrostatic pressure required to move entrapped liquid to overcome the capillary effect. Biosurfactants accumulate at interfaces, thus reducing interfacial tension and leading to the formation of aggregated micellar structures in solution. The formation of micelles provides a physical mechanism to mobilize, for example, oil in a moving aqueous phase.

The ability of biosurfactants to form pores and destabilize biological membranes also permits their use as antibacterial, antifungal, and hemolytic agents to, for example, control pests and/or microbial growth.

Typically, the hydrophilic group of a biosurfactant is a sugar (e.g., a mono-, di-, or polysaccharide) or a peptide, while the hydrophobic group is typically a fatty acid. Thus, there are countless potential variations of biosurfactant molecules based on, for example, type of sugar, number of sugars, size of peptides, which amino acids are present in the peptides, fatty acid length, saturation of fatty acids, additional acetylation, additional functional groups, esterification, polarity and charge of the molecule.

These variations lead to a group of molecules comprising a wide variety of classes, including, for example, glycolipids (e.g., sophorolipids, rhamnolipids, cellobiose lipids, mannosylerythritol lipids and trehalose lipids), lipopeptides (e.g., surfactin, iturin, fengycin, arthrofactin and lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes. Each type of biosurfactant within each class can further comprise subtypes having further modified structures.

Like chemical surfactants, each biosurfactant molecule has its own HLB value depending on its structure; however, unlike production of chemical surfactants, which results in a single molecule with a single HLB value or range, one cycle of biosurfactant production typically results in a mixture of biosurfactant molecules (e.g., subtypes and isomers thereof).

The phrases “biosurfactant” and “biosurfactant molecule” include all forms, analogs, orthologs, isomers, and natural and/or anthropogenic modifications of any biosurfactant class (e.g., glycolipid) and/or subtype thereof (e.g., sophorolipid).

As used herein, the term “sophorolipid,” “sophorolipid molecule,” “SLP” or “SLP molecule” includes all forms, and isomers thereof, of SLP molecules, including, for example, acidic (linear) SLP (ASL) and lactonic SLP (LSL). Further included are mono-acetylated SLP, di-acetylated SLP, esterified SLP, SLP with varying hydrophobic chain lengths, cationic and/or anionic SLP with fatty acid-amino acid complexes attached, esterified SLP, SLP-metal complexes, SLP-salt derivatives (e.g., a sodium salt of a linear SLP), and other, including those that are and/or are not described within in this disclosure.

In preferred embodiments, the SLP molecules according to the subject invention are represented by General Formula (1) and/or General Formula (2), and are obtained as a collection of 30 or more types of structural homologues having different fatty acid chain lengths (R³), and, in some instances, having an acetylation or protonation at R¹ and/or R².

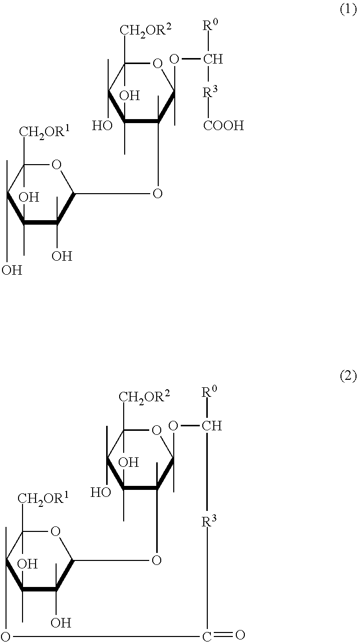

In General Formula (1) or (2), R⁰ can be either a hydrogen atom or a methyl group. R¹ and R² are each independently a hydrogen atom or an acetyl group. R³ is a saturated aliphatic hydrocarbon chain, or an unsaturated aliphatic hydrocarbon chain having at least one double bond, and may have one or more Substituents.

Examples of the Substituents include halogen atoms, hydroxyl, lower (C1-6) alkyl groups, halo lower (C1-6) alkyl groups, hydroxy lower (C1-6) alkyl groups, halo lower (C1-6) alkoxy groups, and others. R³ typically has 11 to 20 carbon atoms. In certain embodiments of the subject invention, R³ has 18 carbon atoms.

SLP are typically produced by yeasts, such as Starmerella spp. yeasts and/or Candida spp. yeasts, e.g., Starmerella (Candida) bombicola, Candida apicola, Candida batistae, Candida floricola, Candida riodocensis, Candida stellate and/or Candida kuoi. SLP have environmental compatibility, high biodegradability, low toxicity, high selectivity and specific activity in a broad range of temperature, pH and salinity conditions. Additionally, in some embodiments, SLP can be advantageous due to their small micelle size, which can help facilitate the movement of the micelle, and compounds enclosed therein, through nanoscale pores and spaces. In certain embodiments, the micelle size of a SLP is less than 100 nm, less than 50 nm, less than 20 nm, less than 15 nm, less than 10 nm, or less than 5 nm.

As used herein, “ore” refers to a naturally occurring solid material from which a valuable substance, mineral and/or metal can be profitably extracted. Ores are often mined from ore deposits, which comprise ore minerals containing the valuable substance. “Gangue” minerals are minerals that occur in the deposit but do not contain the valuable substance. Examples of ore deposits include hydrothermal deposits, magmatic deposits, laterite deposits, volcanogenic deposits, metamorphically reworked deposits, carbonatite-alkaline igneous related deposits, placer ore deposits, residual ore deposits, sedimentary deposits, sedimentary hydrothermal deposits and astrobleme-related deposits. Ores, as defined herein, however, can also include ore concentrates or tailings, copper, or even other sources of metal or valuable minerals, including but not limited to, jewelry, electronic scraps, and other scrap materials.

As used herein, “industrial wastewater” refers to the water that is produced as the result of an industrial activity, including, for example, petroleum refining, chemical production, mining, oil and gas extraction, power production, iron and steel production, battery production, paper making, smelting, textile production, and municipal wastewater treatment.

As used herein “produced water” refers to naturally occurring water that is removed from ground during the extraction of oil and gas, as geological formations that contain oil and gas also contain water.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Recovery Compositions

In certain embodiments, the subject invention provides compositions comprising components that are derived from microorganisms. In certain embodiments, the recovery composition comprises a microbial biosurfactant. In certain embodiments, the composition comprises a biosurfactant, and, optionally, chemical surfactants, activated carbon, zeolites, clays, ion exchanging agents, polymers, adsorbents, salts, acids, or any combination thereof.

In certain embodiments, the recovery composition comprises a microbe-based product comprising a biosurfactant utilized in crude form. The crude form can comprise, in addition to the biosurfactant, fermentation broth in which a biosurfactant-producing microorganism was cultivated, residual microbial cell material or live or inactive microbial cells, residual nutrients, and/or other microbial growth by-products. The product may be, for example, at least, by weight, 1%, 5%, 10%, 25%, 50%, 75%, or 100% broth. The amount of biomass in the product, by weight, may be, for example, anywhere from 0% to 100% inclusive of all percentages therebetween.

In some embodiments, the biosurfactant is utilized after being extracted from a fermentation broth and, optionally, purified.

The biosurfactant according to the subject invention can be a glycolipid (e.g., sophorolipids, rhamnolipids, cellobiose lipids, mannosylerythritol lipids and trehalose lipids), lipopeptide (e.g., surfactin, iturin, fengycin, arthrofactin and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP derivatives, esterified SLP derivatives, amino acid-SLP conjugates, and other SLP derivatives or isomers that exist in nature and/or are produced synthetically. In preferred embodiments, the SLP is a linear SLP or a derivatized linear SLP. In certain embodiments, the subject compositions can comprise lactonic and linear SLP, with at least about 50%, about 55%, about 60%, about 65%, about 70%, about 75%, about 80%, about 85%, about 90%, or about 95% of the SLP comprising linear forms, and the remainder comprising lactonic forms.

In certain embodiments, the activated carbon of the composition is derived from bamboo, coconut husks, willow peat, wood, coir, lignite, coal, petroleum pitch, or any combination thereof.

In certain embodiments, the zeolite of the composition is clinoptilolite, analcime, chabazite, heulandite, natrolite, phillipsite, stilbite, or any combination thereof.

In certain embodiments, the clay is natural or an organoclay, including, for example, kaolinite, montmorillonite-smectite, illite, chlorite, vermiculite, talc, pyrophyllite, or any combination thereof.

In certain embodiments, the ion exchanging agent can be basic (anionic) or acidic (cationic), as determined by the various functional groups of the agent, including, for example, sulfonic groups, quaternary amino groups, carboxylic acid grounds, or primary, secondary, or tertiary amino groups.

In certain embodiments, the polymer can be poly(ethylene oxide), polyacrylamide, polypropylene, polyvinyl chloride, polystyrene, polytetrafluoroethylene, or any combination thereof.

In certain embodiments, the adsorbent can be, for example, starch, alginate, chitin, chitosan, or any combination thereof.

In certain embodiments, the salt can be, for example, carbonates (e.g., sodium carbonate) or aluminum salts (e.g., aluminum chloride, potassium aluminum sulfate).

In certain embodiments, the acid can be acetic acid or carboxylic acid.

In some embodiments, the biosurfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total recovery composition.

In another embodiment, purified biosurfactants may be added in combination with an acceptable carrier, in that the biosurfactant may be presented at concentrations of 0.001 to 50% (v/v), preferably, 0.01 to 20% (v/v), more preferably, 0.02 to 5% (v/v).

In some embodiments, the biosurfactant can be included in the composition at, for example, 0.01 to 100,000 ppm, 0.05 to 10,000 ppm, 0.1 to 1,000 ppm, 0.5 to 750 ppm, 1.0 to 500 ppm, 2.0 to 250 ppm, or 3.0 to 100 ppm, with respect to the amount of industrial wastewater being treated.

In certain embodiments, the chemical surfactant of the recovery composition is a detergent, wetting agent, emulsifier, foaming agent, and/or dispersant. In some embodiments, the chemical surfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total recovery composition.

The recovery composition can further comprise other additives such as, for example, carriers, other microbe-based compositions, additional biosurfactants, enzymes, catalysts, solvents, buffers, chelating agents, emulsifying agents, lubricants, solubility controlling agents, preservatives, stabilizers, ultra-violet light resistant agents, viscosity modifiers, preservatives, tracking agents, biocides, and other microbes and other ingredients specific for an intended use.

In certain embodiments, chelating agents can be, but are not limited to, ethylenediaminetetraacetic acid (EDTA), nitrilotriacetic acid (NTA), a phosphonate, succimer (DMSA), diethylenetriaminepentaacetate (DTPA), N-acetylcysteine, n-hydroxyethylethylenediaminetriacetic acid (HEDTA), organic acids with more than one coordination group (e.g., rubeanic acid), STPP (sodiumtripolyphosphate, Na5P3O10), trisodium phosphate (TSP), water, carbohydrates, organic acids with more than one coordination group (e.g., citric acid), lipids, steroids, amino acids or related compounds (e.g., glutathione), peptides, phosphates, nucleotides, tetrapyrrols, ferrioxamines, ionophores, orphenolics, sodium citrate, sodium gluconate, ethylenediamine disuccinic acid (EDDS), iminodisuccinic acid (IDS), L-glutamic acid diacetic Acid (GLDA), GLDA-Na₄, methyl glycindiacetic acid (MGDA), polyaspartic acid (PASA), hemoglobin, chlorophyll, lipophilic β-diketone, and (14,16)-hentriacontanedione, ethylenediamine-N,N′-diglutaric acid (EDDG), ethylenediamine-N,N′-dimalonic acid (EDDM), 3-hydroxy-2,2-iminodisuccinic acid (HIDS), 2-hydroxyethyliminodiacetic acid (HEIDA), pyridine-2,6-dicarboxylic acid (PDA), trimethyl glycine (TMG), Tiron, or any combination thereof.

Methods of Recovering Materials from Industrial Wastewater

In certain embodiments, the subject invention provides a method for recovering metals, elements, compounds, minerals, and other materials from industrial wastewater, including from, for example, produced water. In certain specific embodiments, the material is copper or lithium.

In certain embodiments, the subject invention provides a method for recovering metals, minerals, elements, compounds, and other material from industrial wastewater, wherein the method comprises the following steps: (i) contacting a composition according to the subject invention with industrial wastewater for a period of time to yield a mixture comprising treated wastewater; and (ii) separating the metals, minerals, elements, compounds, and other material from the remaining wastewater.

The method can be carried out using a column, a filter, a membrane, a solvent, electrolysis, or using any other laboratory or industrial sized reactor.

In some embodiments, step (i) comprises applying a recovery composition comprising a biosurfactant and, optionally, other components, such as, for example, chemical surfactants, activated carbon, zeolites, clays, ion exchanging agents, polymers, adsorbents, salts, and/or acids, to the industrial wastewater. In certain embodiments, the mixture can be pumped or otherwise moved through a membrane, column, resin, adsorbent, or filter. Step (i) can be repeated as many times as necessary to achieve a desired recovery of metals, minerals, elements, compounds, and other material from industrial wastewater.

In certain embodiments, the time period in which the recovering composition can be contacted to industrial wastewater or vessel containing said wastewater is for about 1 second to about 1 year, about 1 minute to about 1 year, about 1 minute to about 6 months, about 1 minute to about 1 month, about 1 minute to about 1 week, about 1 minute to about 48 hours, about 30 minutes to 40 hours, or preferably about 12 hours to 24 hours. In certain embodiments, the methods comprise applying a liquid or solid form of the recovery composition to the industrial wastewater for the period of time in which the industrial wastewater is being produced or until the amount of metals, minerals, elements, compounds, or other materials in the industrial wastewater that have been recovered is determined to be satisfactory or to create wastewater that can be safely and efficiently disposed, which can be readily determined by one skilled in the art. The amount of metals, minerals, elements, compounds, or other materials in the industrial wastewater that may be considered acceptable and/or safe depends on the context. For example, the amount of recovery of particles may be acceptable in higher amounts at mining sites that do not contain toxic compounds than in oil wells that produce toxic compounds, which require expensive disposal methods. Therefore, removing substantial amounts of metals, minerals, elements, compounds, or other materials from industrial wastewater before disposal can reduce costs and allow for the recycling and/or production of additional useful products.

The methods of the subject invention can be carried out at ambient temperature, and/or at a temperature of about 15° C. to about 50° C., about 20° C. to about 40° C., about 20° C. to about 35° C., about 20° C. to about 30° C., about 25° C., about 40° C. to 120° C., about 50° C. to about 100° C., about 60° C. to about 100° C., about 70° C. to about 100° C., about 80° C. to about 100° C., or about 100° C. In certain embodiments, a temperature higher than ambient temperature can be provided using a microwave, ultrasound, induction heating, plasma, electricity, or any combination thereof.

The methods of the subject invention can be carried out at ambient pressure, and/or at a pressure of about 50 bars, 75 bars, 100 bars, or greater than 100 bars.

In certain embodiments, the subject invention provides a method for recovering metals, minerals, elements, compounds, or other materials from various sources of industrial wastewater, including, for example, mining sites, quarrying sites, agricultural sites, oil and gas well, hydraulic fracturing site, chemical production plant, petrochemical production plant, offshore oil drilling rig, and industrial sites.

In certain embodiments, the mining site can be a coal mine, iron ore mine (e.g., taconite), copper mine, copper-nickel mine, tin mine, nickel mine, gold mine, silver mine, molybdenum mine, aluminum mine (e.g., bauxite mine, kyanite mine), lead-zinc mine, tungsten mine, phosphate mine, potash mine, mica mine, bentonite mine, or zinc mine. The mine can be an underground mine, surface mine, placer mine or in situ mine. In certain embodiments, a variety of compounds can be derived from mining activities. In certain embodiments, methods of removing said compounds are provided according to the subject methods by contacting the recovery compositions to various water streams, piping, pumps, water storage areas, or other aquatic environments. The compounds can include, for example, hydrocarbons, organic acids, cyanide, sulfur-bearing minerals, soluble iron, alkali metals, such as, for example, lithium, sodium, and potassium, alkaline-earth metals, such as, for example, barium and calcium, and heavy metals, such as, for example, molybdenum, tungsten, copper, chromium, manganese, nickel, arsenic, zinc, mercury, and vanadium. In certain embodiments, the quarrying site can extract chalk, clay, cinder, coal, sand, gravel, coquina, diabase, gabbro, granite, gritstone, gypsum, limestone, marble, ores, phosphate rock, quartz, sandstone, slate, travertine, or any combination thereof.

In certain embodiments, water can be pumped or otherwise added to the geological formation containing the metal, element, mineral, compound, or other material of interest before the metal, mineral, compound, element, or other material of interest is extracted. In certain embodiments, the subject compositions and methods can be used to recover the metal, element, mineral, compound, or other material from extracted slurries.

In certain embodiments, the source of the industrial wastewater is produced water. Produced water is naturally occurring water that is removed from the ground during the extraction of oil and gas, as geological formations that contain oil and gas also contain water.

In certain embodiments, the source of the industrial wastewater is groundwater or precipitation at industrial sites, including, for example, mines, quarries, and oil and gas wells.

In certain embodiments, the source of the industrial wastewater is the water that is pumped or otherwise applied into the ground or geologic formation, during, for example, hydraulic fracturing.

In certain embodiments, the microbe-containing and/or biosurfactant-containing composition can improve agglomeration between the particles or particles and a surface, such as, for example, agglomerating lithium salt particles to each other.

In certain embodiments, the microbe-containing and/or biosurfactant-containing composition can form a layer of agglomerated particulate around and/or between particles suspended in a liquid.

The compositions can be applied to liquids or vessels that contain liquids that reside at a range of temperatures and aquatic environments, such as, for example, a stream, river, waterway, ocean, sea, lake, pond, runoff area, containment ponds, piping, filter, press, membrane, column, screen, cone, dewaterer, classifier, scraper, hydrocyclone, agitator, drum, disk, or industrial wastewater treatment/holding tank. In certain embodiments, the recovery composition can be added to the vessels that contain liquids before the liquid composition is added to said vessel.

The recovery composition can be applied to a liquid and, optionally, mixed by adding, pouring, or combining.

In certain embodiments, the amount of the recovery composition applied is about 0.1 to 15%, about 0.1 to 10%, about 0.1 to 5%, about 0.1 to 3%, about 0.1%, or about 1 vol % based on an amount of the industrial wastewater.

In certain embodiments, the methods of the subject invention result in at least a 25% increase in the recovery of particles, preferably at least a 50% increase, after one treatment. In certain embodiments, the industrial wastewater can be treated multiple times to further increase the amount of recovered particles.

In certain embodiments, the recovered materials can comprise, fat, oil, grease, dissolved organic compounds, volatile organic compounds, heavy metals (e.g., manganese, iron, copper, zinc, lead, nickel, cobalt, cadmium, and chromium), radionuclides, bacteria, and chemical additives used in the removal of the oil or gas from the well (e.g., biocides, scale inhibitors, corrosion inhibitors, emulsifiers), and lithium.

In certain embodiments, the method comprises aerating the wastewater in the presence of a recovery composition according to the subject invention. In certain embodiments, the composition serves as a collector to facilitate the attachment of air bubbles to particles of the target metal or mineral within the wastewater (e.g., the concentrate), which allows for flotation of the concentrate particles to the surface of the wastewater. In alternative embodiments, the composition serves as a collector to facilitate the attachment of air bubbles to fat, oil, grease, or suspended solids in wastewater, which allows for flotation of the fat, oil, grease, or other suspended solids to the surface of the wastewater (i.e., dissolved air flotation (DAF)). In some embodiments, the method is performed in a tank, vat, column, pool or other vessel.

In preferred embodiments, the subject invention provides a method for maintaining or improving oil refining, natural gas processing, or petrochemical production efficiency by applying the recovery composition to wastewater effluents from the refineries or chemical production facilities. In certain embodiments, the recovery compositions can be used in an API oil-water separator, which separates oil droplets from water, or DAF, which can separate oil and other solids, to which the air bubbles attach, from water. In certain embodiments, the resulting wastewater can be subjected to additional treatments, such as, for example, activated sludge treatment in which microorganisms oxidize organic pollutants in the water. The resulting water can be reused in, for example, the refinery or petrochemical production plant or disposed of.

In some embodiments, the metals, minerals, elements, compounds, or other materials is obtained from industrial wastewater in a raw form. This raw form can comprise additional materials, or gangue. Thus, in certain embodiments, the method can further comprise, after obtaining the metals, minerals, elements, compounds, or other materials, after treating the industrial wastewater with the recovery composition, subjecting the metals, minerals, elements, compounds, or other materials to one or more beneficiation processes. The one or more beneficiation processes can include, for example, comminution, scrubbing, washing, screening, flotation, and/or hydrocycloning.

Advantageously, in certain embodiments, the recovery composition according to the subject invention provides enhanced or increased efficiency at recovering metals, minerals, elements, compounds, or other materials from industrial wastewater with limited negative environmental impacts. Additionally, the methods of the subject invention do not require complicated equipment or high energy consumption, and production of the recovery composition can be performed on site, for example, at an ore mine or at an oil or gas well. In certain embodiments, the subject recovery composition can result in a decreased use of chemical surfactants or other potentially harmful chemicals during the recovery of metals, minerals, elements or other materials from industrial wastewater. Furthermore, the metals, minerals, elements or other materials recovered from industrial wastewater according to the subject invention can be useful for producing more environmentally-friendly, products, including, for example, wiring, batteries, jewelry, electronic components, and heat shielding.

### Production of Microbe-Based Products

In certain embodiments, the subject invention provides methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

The microorganisms can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In certain embodiments, the microbes are capable of producing amphiphilic molecules, enzymes, proteins and/or biopolymers. Microbial biosurfactants, in particular, are produced by a variety of microorganisms such as bacteria, fungi, and yeasts, including, for example, Agrobacterium spp. (e.g., A. radiobacter); Arthrobacter spp.; Aspergillus spp.; Aureobasidium spp. (e.g., A. pullulans); Azotobacter (e.g., A. vinelandii, A. chroococcum); Azospirillum spp. (e.g., A. brasiliensis); Bacillus spp. (e.g., B. subtilis, B. amyloliquefaciens, B. pumillus, B. cereus, B. licheniformis, B. firmus, B. laterosporus, B. megaterium); Blakeslea; Candida spp. (e.g., C. albicans, C. rugosa, C. tropicalis, C. lipolytica, C. torulopsis); Clostridium (e.g., C. butyricum, C. tyrobutyricum, C. acetobutyricum, and C. beijerinckii); Campylobacter spp.; Cornybacterium spp.; Cryptococcus spp.; Debaryomyces spp. (e.g., D. hansenii); Entomophthora spp.; Flavobacterium spp.; Gordonia spp.; Hansenula spp.; Hanseniaspora spp. (e.g., H. uvarum); Issatchenkia spp; Kluyveromyces spp.; Meyerozyma spp. (e.g., M. guilliermondii); Mortierella spp.; Mycorrhiza spp.; Mycobacterium spp.; Nocardia spp.; Pichia spp. (e.g., P. anomala, P. guilliermondii, P. occidentalis, P. kudriavzevii); Phycomyces spp.; Phythium spp.; 15 Pseudomonas spp. (e.g., P. aeruginosa, P. chlororaphis, P. putida, P. florescens, P. fragi, P. syringae); Pseudozyma spp. (e.g., P. aphidis); Ralslonia spp. (e.g., R. eulropha); Rhodococcus spp. (e.g., R. erythropolis); Rhodospirillum spp. (e.g., R. rubrum); Rhizobium spp.; Rhizopus spp.; Saccharomyces spp. (e.g., S. cerevisiae, S. boulardii sequela, S. torula); Sphingomonas spp. (e.g., S. paucimobilis); Starmerella spp. (e.g., S. bombicola); Thraustochytrium spp.; Torulopsis spp.; Ustilago spp. (e.g., U. maydis); Wickerhamomyces spp. (e.g., W. anomalus); Williopsis spp.; and/or Zygosaccharomyces spp. (e.g., Z. bailii).

In preferred embodiments, microorganism is a Starmerella spp. yeast and/or Candida spp. yeast, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g., small molecules and excreted proteins), residual nutrients and/or intracellular components (e.g., enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹², 1×10⁷ to 1×10¹¹, 1×10⁸ to 1×10¹⁰, or 1×10⁹ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

In certain embodiments, the subject invention provides a “microbe-based composition,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. The microbes may be present in or removed from the composition. The microbes can be present, with broth in which they were grown, in the microbe-based composition. The cells may be present at, for example, a concentration of at least 1×10³, 1×10⁴, 1×10⁵, 1×10⁶, 1×10⁷, 1×10⁸, 1×10⁹, 1×10¹⁰, 1×10¹¹, 1×10¹², 1×10¹³ or more CFU per milliliter of the composition.

The subject invention further provides “microbe-based products,” which are products that are to be applied in practice to achieve a desired result. The microbe-based product can be simply a microbe-based composition harvested from the microbe cultivation process. Alternatively, the microbe-based product may comprise further ingredients that have been added. These additional ingredients can include, for example, stabilizers, acids, buffers, carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored at ambient temperatures.

1. A method for recovering a metal, mineral, element, or compound from industrial wastewater, the method comprising:
(i) contacting a recovery composition comprising a biosurfactant with industrial wastewater for a period of time to yield a treated wastewater; and
(ii) separating the metal, mineral, element, or compound from the treated wastewater.

2. The method of claim 1, wherein step (ii) comprises filtering, centrifugation, flotation, settling, or any combination thereof.

3-4. (canceled)

5. The method of claim 1, wherein the wastewater is mining wastewater, quarrying wastewater, or industrial wastewater.

6. The method of claim 5, wherein the mining wastewater is from a coal mine, iron ore mine, copper mine, copper-nickel mine, tin mine, nickel mine, gold mine, silver mine, molybdenum mine, aluminum mine, lead-zinc mine, tungsten mine, phosphate mine, potash mine, mica mine, bentonite mine, or zinc mine.

7. The method of claim 5, wherein the industrial wastewater is produced water from an oil or gas well, at a hydraulic fracturing site, or at an offshore oil drilling rig or water derived from a chemical production plant or petrochemical production plant.

8. (canceled)

9. The method of claim 1, wherein step (ii) further comprises a beneficiation process.

10-11. (canceled)

12. The method of claim 1, wherein the biosurfactant is a glycolipid and/or wherein the recovery composition comprises a yeast culture comprising a glycolipid.

13. The method of claim 12, wherein the yeast culture is a Starmerella sp. and/or a Candida sp. yeast.

14. The method of claim 12, wherein the recovery composition comprises a glycolipid selected from sophorolipids, mannosylerythritol lipids, trehalose lipids, and rhamnolipids.

15. (canceled)

16. The method of claim 1, wherein the recovering comprises removing the metal, mineral, element, or compound from industrial wastewater by at least one of the following:
a) adhering the particle to a surface and/or object;
b) agglomerating particles together; and
c) settling the particle.

17. (canceled)

18. A method for recovering a fat, oil, grease, or suspended solid from industrial wastewater, the method comprising:
(i) contacting a recovery composition comprising a biosurfactant with industrial wastewater for a period of time to yield a treated wastewater; and
(ii) separating the fat, oil, grease, or suspended solid from the treated wastewater.

19-26. (canceled)

27. The method of claim 18, wherein the biosurfactant is a glycolipid and/or wherein the recovery composition comprises a yeast culture comprising a glycolipid.

28. The method of claim 27, wherein the yeast culture is a Starmerella sp. and/or a Candida sp. yeast.

29. The method of claim 27, wherein the recovery composition comprises a glycolipid selected from sophorolipids, mannosylerythritol lipids, trehalose lipids, and rhamnolipids.

30. (canceled)

31. The method of claim 18, wherein the recovering comprises removing the fat, oil, grease, or suspended solid from industrial wastewater by at least one of the following:
a) adhering the fat, oil, grease, or suspended solid to a surface and/or object;
b) agglomerating the fat, oil, grease, or suspended solid together; or
c) floating the fat, oil, grease, or suspended solid to the surface of the industrial wastewater.

32-37. (canceled)
